(19) United States
(12) Patent Application Publication
(10) Pub. No.: US 2025/0214787 A1
(43) Pub. Date: Jul. 3, 2025

(54) FLOATING UNIT

(71) Applicant: Eitzenberger GmbH, Wessobrunn (DE)

(72) Inventor: Janis WORTMANN, Wessobrunn (DE)

(73) Assignee: Eitzenberger GmbH, Wessobrunn (DE)

(21) Appl. No.: 18/835,009

(22) PCT Filed: Jan. 17, 2023
(86) PCT No.: PCT/EP2023/050943

§ 371 Date: Jul. 31, 2024

(30) Foreign Application Priority Data
Jan. 31, 2022 (DE) 102022102162.9

(51) Int. Cl. B65G 51/03; B65G 49/06

(52) U.S. Cl. CPC B65G 51/03; B65G 49/065; B65G 2201/022; B65G 2203/0233; B65G 2203/044; B65G 2249/04

(57) ABSTRACT

A floating unit carries and transport is a substantially flat body, with a carrier plate which has a first multiplicity of pressure nozzles and a first multiplicity of vacuum nozzles on a first surface, wherein a first multiplicity of channels which extend both from the pressure nozzles of the first multiplicity of pressure nozzles and from the vacuum nozzles of the first multiplicity of vacuum nozzles is provided in the first surface.

### CROSS-REFERENCE TO RELATED APPLICATIONS

This application is a national stage under 35 U.S.C. § 371 of PCT patent application PCT/EP2023/050943 filed on 17 Jan. 2023, which is pending and which is hereby incorporated by reference in its entirety for all purposes. PCT/EP2023/050943 claims priority to German Patent Application 102022102162.9 filed on 31 Jan. 2022, which is hereby incorporated by reference in its entirety for all purposes.

### BACKGROUND OF THE INVENTION

### 1. Field of the Invention

The invention relates to a floating unit for carrying and transporting an essentially flat body, with a carrier plate which has a first multiplicity of pressure nozzles and a first multiplicity of vacuum nozzles on a first surface.

### 2. Discussion of the Related Art

Devices of this type are used in order to safely carry and precisely position flat bodies. In particular, floating units are used in order to coat glass panes for screen production. During the coating, such a glass pane hovers over the carrier plate at a defined distance of, for example, a few μm to the carrier plate. This is achieved by the interplay of pressure nozzles and vacuum nozzles. This means that an air cushion is not simply afforded by pressure nozzles which operate against the ambient pressure; thus, the exact positioning requirements could not be met. The interaction of positive pressure and negative pressure makes it possible to position the glass panes so precisely that they can be moved in the narrow focus of a stationary laser.

A floating unit which fulfills the aforementioned purposes is described, for example, in document U.S. Pat. No. 9,022,699 B2.

The floating units of the state of the art cause considerable consumption of compressed air, which can lead to significant energy costs in industrial-scale plants. Likewise, systems of the prior art are often not sufficiently “stiff” with regard to the distance between the carrier plate and the glass pane, so that unacceptable tolerances can occur in the distance between the carrier plate and the glass pane, for example due to unevenness in the glass pane. This makes it difficult to precisely position the glass pane and presents problems in case of insufficient support for the glass pane in the edge area of a carrier plate, for example when the glass pane is transferred from one floating unit to an adjacent floating unit.

### SUMMARY OF THE INVENTION

The object of the invention is to afford a floating unit with optimized precision and reduced compressed air consumption.

The floating unit according to the present invention is based on the state of the art in that a first multiplicity of channels which extend both from the pressure nozzles of the first multiplicity of pressure nozzles and from the vacuum nozzles of the first multiplicity of vacuum nozzles is provided in the first surface. By supplying pressure and vacuum channels, an extremely precise and extremely small distance between the flat body and the carrier plate can be ensured. The small distance ensures a high pneumatic resistance, which in turn ensures a low compressed air consumption and, as a consequence thereof, low energy costs.

It is particularly preferred that the channels of the first multiplicity of channels are arranged in parallel.

In this case, it is provided in particular that channels associated with pressure nozzles and channels associated with vacuum nozzles are provided alternately perpendicular to their extension.

It is usefully provided that the channels extend from each pressure nozzle of the first multiplicity of pressure nozzles and from each vacuum nozzle of the first multiplicity of vacuum nozzles in opposite directions starting from the pressure nozzles and the vacuum nozzles. As a result of this arrangement, the compressed air is distributed evenly, and it is also discharged in a form adapted thereto via the vacuum nozzles.

It can be particularly advantageous that the pressure nozzles of the first multiplicity of pressure nozzles and the vacuum nozzles of the first multiplicity of vacuum nozzles are each arranged in the center of the channels.

For the shape of the channels, experiments have shown that it is advantageous that the channels taper in their cross-section from the first surface of the carrier plate into a depth of the carrier plate.

Furthermore, it is particularly useful that the pressure nozzles of the first multiplicity of pressure nozzles have a smaller cross-section than the vacuum nozzles of the first multiplicity of vacuum nozzles. It is thus possible to afford pressure-mass flow characteristics which ensure a small distance between the glass pane and the carrier plate as well as extremely high stiffness of the pneumatic system.

In line with this, it is provided that the channels extending from the pressure nozzles of the first multiplicity of pressure nozzles have a smaller cross-section than the channels extending from the vacuum nozzles of the first multiplicity of vacuum nozzles. In this case, the channels have, for example, a length of 18 mm and a mutual distance of 6.1 mm. The width of the channels can be in the range of 50 μm, as can their depth. However, it is preferred that the pressure channels, adapted to the smaller pressure nozzle size, are narrower and possibly flatter than the vacuum channels by a factor of 2 to 3.

Overall, it is useful that the first multiplicity of pressure nozzles, the first multiplicity of vacuum nozzles and the associated channels have a regular first arrangement pattern. Although a strict regularity in the arrangement of the nozzles and channels is not absolutely necessary, it is preferable in view of the desired low tolerances.

Furthermore, it can be provided that a second multiplicity of pressure nozzles is provided in a transport direction provided for the flat body, following the first arrangement pattern, which have a second arrangement pattern which differs from the first arrangement pattern. Vacuum nozzles do not necessarily have to be associated with this second multiplicity of pressure nozzles. The carrier plate then displays a first arrangement pattern which defines the small distance between glass pane and carrier plate with the required stiffness. The second multiplicity of pressure nozzles then simply affords an air cushion against atmospheric pressure which carries the plate, approximately in the manner of an air hockey table.

It may also be useful to edge pressure nozzles with edge channels extending therefrom are provided in an edge area of the first surface of the carrier plate, wherein the edge channels are not parallel to the channels associated with the first multiplicity of pressure nozzles and vacuum nozzles. Thus, additional support of the glass pane is afforded in the edge area of the carrier plate, counteracting any unwanted downward tilt of the glass pane if it protrudes beyond the carrier plate.

It has proven to be useful that the edge channels are perpendicular to the channels associated with the first multiplicity of pressure nozzles and vacuum nozzles.

The floating unit according to the invention is further developed in a particularly advantageous manner in that a pressure nozzle of the first multiplicity of pressure nozzles follows a first pressure/mass flow function and in that a vacuum nozzle of the first multiplicity of vacuum nozzles follows a second pressure/mass flow function, that in a first mass flow an absolute value of the pressure according to the first pressure/mass flow function is greater than an absolute value of the pressure according to the second pressure/mass flow function and that there is a second mass flow which is greater than the first mass flow in which the absolute values of the pressure of both pressure/mass flow functions are identical, wherein the second mass flow corresponds to a stable distance between the flat body and the carrier plate. At a low mass flow, a lower pressure prevails at the smaller pressure nozzle than at the larger vacuum nozzle, always in absolute pressure values. If the mass flow increases, however, the pressure/mass flow function of the pressure nozzle decreases faster than the pressure/mass flow function of the vacuum nozzle. Consequently, a mass flow value can be achieved at which the pressures at the pressure nozzle and the vacuum nozzle are identical. This defines the stable distance between the glass pane and the carrier plate.

This is also related to the fact that, in the second mass flow, an absolute value of a slope of a tangent to the first pressure/mass flow function is greater than an absolute value of a slope of a tangent to the second pressure/mass flow function. The greater the difference between the slopes of the tangents to the pressure/mass flow functions, the stiffer the pneumatic system.

The floating unit according to the invention is further developed in that a distributor for supplying and discharging air is arranged on a second surface of the carrier plate opposite the first surface. The distributor communicates with holes in the carrier plate for feeding and discharging the air.

It is further provided that a laser device is provided for detecting a position of the flat body. This laser device is generally used for positioning the glass pane on the carrier plate. However, it can also intervene in the pneumatic system in that the delivery and discharge volumes of compressed air are controlled or regulated depending on signals detected by laser optics.

In order to transport and process large flat bodies, it is provided to afford a system consisting of several floating units, wherein the first surfaces of the floating units lie in one plane. Thus, the glass panes can be transferred from one floating unit to an adjacent floating unit.

### BRIEF DESCRIPTION OF THE DRAWINGS

The invention will now be explained with reference to the accompanying drawings by way of examples.

FIG. 1 shows a side view of a floating unit with a flat body carried by the floating unit.

FIG. 2 shows a top view of a first embodiment of a floating unit.

FIG. 3 shows nozzles with associated channels.

FIG. 4 shows a cross-section of a channel.

FIG. 5 shows a top view of a second embodiment of a floating unit.

FIG. 6 shows a top view of a third embodiment of a floating unit.

FIG. 7 shows a pressure-mass flow diagram.

In the following description of the drawings, identical reference numerals denote identical or comparable components.

### DESCRIPTION OF THE INVENTION

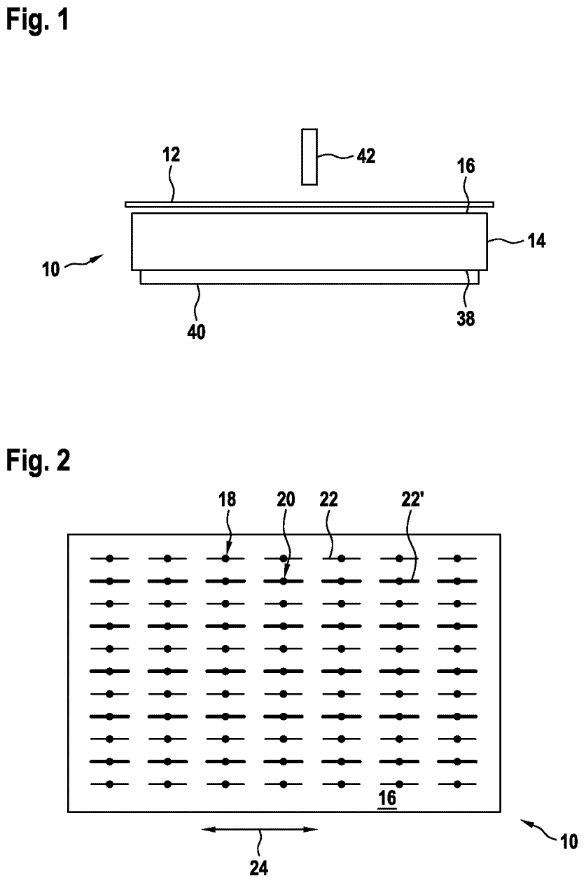

FIG. 1 shows a side view of a floating unit 10 with a flat body 12 carried by the floating unit 10. FIG. 2 shows a top view of a first embodiment of a floating unit 10. The floating unit 10 has a carrier plate 14 with a first surface 16. This is preferably a metal surface, for example made of aluminum or steel. The surface 16 can be treated, for example anodized. It is advantageous if the surface 16 has a good flatness, approximately in the range of 10 μm. A multiplicity of pressure nozzles 18 and a multiplicity of vacuum nozzles 20 are provided in the surface 16. A channel 22 (a pressure channel) extends from each pressure nozzle 18 and a channel 22′ (a vacuum channel) extends from each vacuum nozzle 20. Both the pressure nozzles 18 and the vacuum nozzles 20 lie in the center of the associated channels 22, 22′. The pressure nozzles 18 and the vacuum nozzles 20 or the associated channels 22, 22′ are arranged in parallel and are provided alternately perpendicular to their extension. In the present embodiment example, the channels form exact “columns” perpendicular to their extension. This is not mandatory. An arrangement with a certain offset is also possible. The last “row” of pressure nozzles 18 and the channels 22 associated with the pressure nozzles 18 are located at the edges of the carrier plate 14 perpendicular to the extension of the channels. The direction of movement or the transport direction of the flat body 12 is indicated by the double arrow 24. A compressed air distributor 40 is provided on a surface 38 of the carrier plate 14 which is arranged opposite the surface 16. This affords the required air pressures to pressure channels and vacuum channels which extend vertically through the carrier plate 14. The channels 22 associated with the pressure nozzles 18 are drawn with a finer line than the channels 22′ associated with the vacuum nozzles 20. Thus, it is symbolically shown that the vacuum nozzles 20 and the associated channels 22′ are larger in cross-section than the pressure nozzles 18 and the associated channels 22, for example by a factor of 2 to 3. The number of nozzles 18, 20 and channels 22, 22′ in the carrier plate can vary greatly, in particular depending on the application. For example, several hundred nozzles 18, 20 as well as channels 22, 22′ or even several tens of thousands of nozzles 18, 20 and channels 22, 22′ can be provided per floating unit 10. The positions of the nozzles 18, 20 are shown in the drawings as thick dots in the center of the lines symbolizing the channels 22, 22′. The thickness of the dots does not correlate with the cross-sections of the nozzles 18, 20. Rather, the nozzles are arranged at the bottom of the channels 22, 22′ so that their diameter is not greater than the width of the channels 22, 22′.

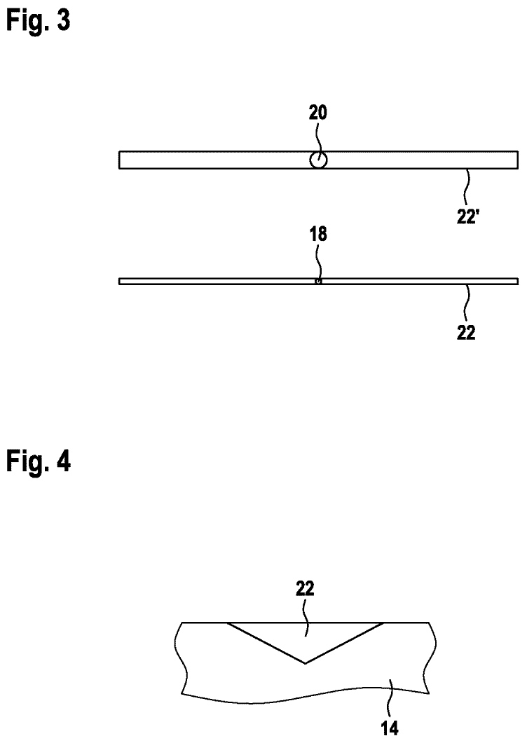

FIG. 3 shows nozzles 18, 20 with associated channels 22, 22′. Here, the fact that both the nozzles 18, 20 and the channels 22, 22′ have different dimensions is illustrated graphically.

FIG. 4 shows a cross-section of a channel. In principle, the channels 22, 22′ can have different cross-sections. In a proven embodiment, the channels 22, 22′ taper into the depth of the carrier plate 14, which is illustrated in the present case using the example of a pressure channel 22. The cross-section is almost V-shaped.

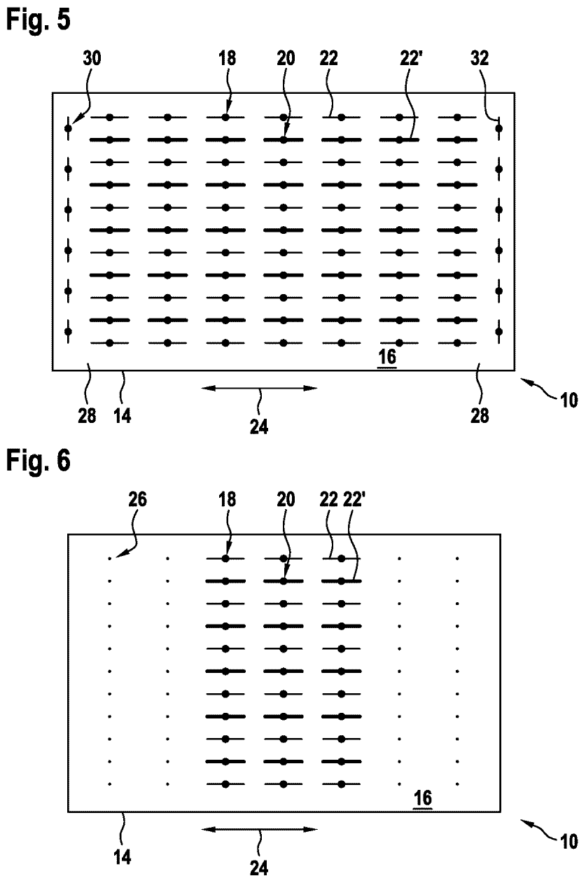

FIG. 5 shows a top view of a second embodiment of a floating unit 10. The arrangement of pressure nozzles 18, vacuum nozzles 20 and associated channels 22, 22′ is similar to that of the embodiment example according to FIG. 2. In addition, edge nozzles 30 and associated edge channels 32 are provided at the edges of the carrier plate 14, over which a glass pane must be transported, these being exclusively pressure nozzles. The glass panes thus receive additional support in the edge area.

FIG. 6 shows a top view of a third embodiment of a floating unit. Here there are only three columns of alternately arranged pressure nozzles 18 and vacuum nozzles 20 as well as pressure channels 22 and vacuum channels 22′. These few columns may be sufficient to define the distance between the glass pane and the carrier plate 14 and to afford sufficient rigidity to the pneumatic system. Only additional pressure nozzles 26 which additionally carry the glass pane in the manner of an air hockey table are then arranged in the edge areas of the carrier plate 14. These pressure nozzles 26 may be arranged substantially less densely. Channels can be connected to the pressure nozzles 26.

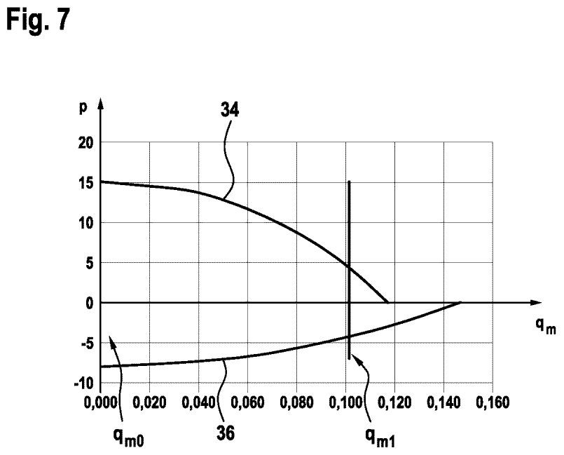

FIG. 7 shows a pressure-mass flow diagram. In this diagram, the pressure p at the nozzle outlet is plotted in bar against the mass flow qₘ in arbitrary units. The upper graph 34 corresponds to the pressure/mass flow function of a pressure nozzle, while the lower graph 36 follows a pressure/mass flow function of a vacuum nozzle. At a very low mass flow qₘ₀, a pressure with a higher absolute value prevails at the small pressure nozzle than at the larger vacuum nozzle. However, with increasing mass flow, the pressure/mass flow function 34 of the pressure nozzle decreases faster than the pressure/mass flow function of the vacuum nozzle 36. With a suitable design, there is then a mass flow value qₘ₁ at which the absolute values of the pressures at the pressure nozzle and vacuum nozzle are identical. This is the stable state, which defines the distance between the glass pane and the carrier plate. The tangents to the pressure/mass flow functions at qₘ₁ are decisive for the stiffness of the pneumatic system. The greater the difference in the slopes of the tangents, the stiffer the system.

The features of the invention disclosed in the above description, in the drawings and in the claims can be essential for the realization of the invention both individually and in any combination.

### LIST OF REFERENCE NUMERALS

10 Floating unit
12 Flat body
14 Carrier plate
16 First surface
18 Pressure nozzle
20 Vacuum nozzle
22 Channel
22′ Channel
24 Transport direction
26 Pressure nozzle
28 Edge area
30 Edge pressure nozzle
32 Edge channel
34 Pressure/mass flow function
36 Pressure/mass flow function
38 Second surface
40 Distributor
42 Laser device
qₘ₀ First mass flow
qₘ₁ Second mass flow

1.-17. (canceled)

18. A floating unit for carrying and transporting a substantially flat body, the floating unit comprising:
a carrier plate, the carrier plate comprising:
a first plurality of pressure nozzles, and
a first plurality of vacuum nozzles on a first surface,
wherein a first plurality of channels which extend both from the pressure nozzles of the first plurality of pressure nozzles and from the vacuum nozzles of the first plurality of vacuum nozzles is provided in the first surface.

19. The floating unit according to claim 18, wherein the channels of the first plurality of channels are arranged in parallel.

20. The floating unit according to claim 18, wherein the channels associated with pressure nozzles and the channels associated with vacuum nozzles are provided alternately perpendicular to their extension.

21. The floating unit according to claim 18, wherein the channels extend from each pressure nozzle of the first plurality of pressure nozzles and from each vacuum nozzle of the first plurality of vacuum nozzles in opposite directions starting from the pressure nozzles and the vacuum nozzles.

22. The floating unit according to claim 21, wherein the pressure nozzles of the first plurality of pressure nozzles and the vacuum nozzles of the first plurality of vacuum nozzles are each arranged in the center of the channels.

23. The floating unit according to claim 18, wherein the channels taper in their cross-section from the first surface of the carrier plate into a depth of the carrier plate.

24. The floating unit according to claim 18, wherein the pressure nozzles of the first plurality of pressure nozzles have a smaller cross-section than the vacuum nozzles of the first plurality of vacuum nozzles.

25. The floating unit according to claim 18, wherein the channels extending from the pressure nozzles of the first plurality of pressure nozzles have a smaller cross-section than the channels extending from the vacuum nozzles of the first plurality of vacuum nozzles.

26. The floating unit according to claim 18, wherein the first plurality of pressure nozzles, the first plurality of vacuum nozzles and the associated channels have a regular first arrangement pattern.

27. The floating unit according to claim 18, wherein a second plurality of pressure nozzles is provided in a transport direction provided for the flat body, following the first arrangement pattern, which have a second arrangement pattern which differs from the first arrangement pattern.

28. The floating unit according to claim 18, wherein edge pressure nozzles with edge channels extending therefrom are provided in an edge area of the first surface of the carrier plate, wherein the edge channels are not parallel to the channels associated with the first plurality of pressure nozzles and vacuum nozzles.

29. The floating unit according to claim 18, wherein the edge channels are perpendicular to the channels associated with the first plurality of pressure nozzles and vacuum nozzles.

30. The floating unit according to claim 18, wherein a pressure nozzle of the first plurality of pressure nozzles follows a first pressure/mass flow function and in that a vacuum nozzle of the first plurality of vacuum nozzles follows a second pressure/mass flow function, that in a first mass flow (qₘ₀) an absolute value of the pressure according to the first pressure/mass flow function is greater than an absolute value of the pressure according to the second pressure/mass flow function and that there is a second mass flow (qₘ₁) which is greater than the first mass flow (qₘ₀) in which the absolute values of the pressure of both pressure/mass flow functions are identical, wherein the second mass flow (qₘ₁) corresponds to a stable distance between the flat body and the carrier plate.

31. The floating unit according to claim 30, wherein in the second mass flow (qₘ₁), an absolute value of a slope of a tangent to the first pressure/mass flow function is greater than an absolute value of a slope of a tangent to the second pressure/mass flow function.

32. The floating unit according to claim 18, wherein a distributor for supplying and discharging air is arranged on a second surface of the carrier plate opposite the first surface.

33. The floating unit according to claim 18, wherein a laser device is provided for detecting a position of the flat body.

34. A system for carrying and transporting at least one substantially flat body, the system comprising:
at least two floating units, each floating unit for carrying and transporting the at least one substantially flat body, each floating unit comprising:
a carrier plate, the carrier plate comprising:
a first plurality of pressure nozzles, and
a first plurality of vacuum nozzles on a first surface,
wherein a first plurality of channels which extend both from the pressure nozzles of the first plurality of pressure nozzles and from the vacuum nozzles of the first plurality of vacuum nozzles is provided in the first surface, and
wherein the first surfaces of the floating units lie in one plane.
